(19) United States
(12) Patent Application Publication
(10) Pub. No.: US 2004/0037502 A1
(43) Pub. Date: Feb. 26, 2004

(54) Wavelength division multiplexer with fiber bragg gratings

(76) Inventor: Jeong-Hwan Song, Seoul (KR)

Correspondence Address: CHA & REITER, LLC, 210 ROUTE 4 EAST, PARAMUS, NJ, 07652, US

(21) Appl. No.: 10/427,663

(22) Filed: May 1, 2003

(30) Foreign Application Priority Data
Aug. 23, 2002 (KR) 2002-50114

(51) Int. Cl. G02B 6/34; G02B 6/28

(52) U.S. Cl. 385/37; 385/24

(57) ABSTRACT

Disclosed is a wavelength-division multiplexer for providing a plurality of optical-signal-transmitting channels by dividing an input-optical-signal band. The wavelength-division multiplexer includes an optical block for dividing the input-optical-signal band into a plurality of bragg wavelengths including side lobes and for accommodating a plurality of bragg-fiber gratings connected to each other in series, such that a peak of a side lobe is matched with the optical-signal-transmitting channel. An isolator is provided to shut off a part of the wavelengths of the input-optical-signal band, which is reflected from the bragg-fiber gratings. A planar waveguide-array-grating chip divides the input-optical-signal band, which is inputted from the optical-fiber block, into a plurality of channels. An output-terminal optical-fiber block is connected to an output terminal of the planar waveguide-array-grating chip.

### CLAIM OF PRIORITY

This application claims priority to an application entitled “WAVELENGTH DIVISION MULTIPLEXER WITH FIBER BRAGG GRATINGS,” filed in the Korean Industrial Property Office on Aug. 23, 2002 and assigned Serial No. 2002-50114, the contents of which are hereby incorporated by reference.

### BACKGROUND OF THE INVENTION

1. Field of the Invention

The present invention relates to a wavelength-division multiplexer and, more particularly, to a wavelength-division multiplexer used in forming a planar channel.

2. Description of the Related Art

A wavelength-division multiplexer (WDM) plays an important role in improving the efficiency of an optical-communication network and in increasing the processing capacity. The wavelength-division multiplexers (WDMs) with a waveguide-array grating are available in the form of 1×N and N×N multiplexers, Recently, as the channel capacity and the demand for it have increased dramatically, the channels of WDMs are further subdivided.

FIG. 1 is a view explaining the optical-signal distribution of a conventional wavelength-division multiplexer. As shown, the space formed between an input-waveguide array 110 and an optical-waveguide-array grating 120, and the space formed between an output-waveguide-array grating 130 and the optical-waveguide-array grating 120 are referred to as a free-space region or a slab.

The optical-waveguide-array grating includes a plurality of optical waveguides about one central wavelength. An optical-path difference between the optical waves passing through the optical waveguides is predetermined in such a way that the optical-path difference is in an integer ratio with respect to the central wavelength. The optical-path difference is obtained through multiplying the difference of forward distances of the optical waves by the refraction rate of a medium of the optical waves.

Referring to FIG. 1, the wave front radiated from one end of the input-waveguide array 110 (in which, A=0) is converged to one end of the output-waveguide array 130 (in which, B=0) via the optical-waveguide array 120. Note that the optical waves passing through the iₜₕ and i−1ₜₕ optical waveguides forming the optical-waveguide-array grating 120 satisfy the following equation 1.

mλ=n₁dθᵢ+n₂ΔLᵢ+ndαᵢ, Equation 1

ΔLᵢ=Lᵢ−Lᵢ₋₁

In the above Equation 1, m represents a predetermined integer, λ represents a wavelength to be used, Lᵢ represents the length of the iₜₕ optical waveguide forming the optical-waveguide-array grating, n₁ represents an effective refraction rate of slabs with respect to the wavelength to be used, n₂ represents an effective refraction rate of optical waveguides forming the optical waveguide-array grating with respect to the wavelength to be used, θᵢ represents an angle between the straight line extending from one end of a first waveguide (in which, A=0) to one end of a 0ₜₕ optical waveguide of the optical-waveguide-array grating and the straight line extending from the end of the first waveguide (in which A=0) to an end of the iₜₕ optical waveguide of the optical-waveguide-array grating, αᵢ represents an angle between the straight line extending from one end of the output-waveguide array 130 (in which, B=0) to one end of the 0ₜₕ optical waveguide of the optical-waveguide-array grating 120 and the straight line extending from the end of the output-waveguide array 130 (in which, B=0) to one end of the iₜₕ optical waveguide of the optical-waveguide-array grating 120, and d represents an interval between the optical waveguides forming the optical-waveguide-array grating 120. On the assumption that the angles described in Equation 1 are small, an approximate equation 2 can be achieved as follows:

sin(θ)=tan(θ)=θ, Equation 2

cos(θ)=1

Using Equation 2, the angles described in Equation 1 can be approximated as can be seen in the following equation 3:

θᵢ=id/z₀ Equation 3

αᵢ=id/f

In the above Equation 3, z₀ represents the distance between one end of the input-waveguide array 110 (in which, A=0) and one end of the 0ₜₕ optical waveguide of the optical-waveguide-array grating 120, and f represents the distance between the one end of the output-waveguide array 130 (in which, B=0) and the one end of the 0ₜₕ optical waveguide of the optical-waveguide-array grating 120. By applying Equation 3 to Equation 1, an equation 4 is obtained as follows:

mλ=in₁d²/z₀+n₂ΔLᵢ+in₁d²/f Equation 4

The relationship between z₀ and f can be understood from Equation 4. That is, when the distance between the input-waveguide array 110 and the optical-waveguide-array grating 120 is varied, a proper position of the output-waveguide array 130 can be determined by using Equation 4. In addition, as shown in FIG. 1, the signal light radiated from the optical-waveguide-array grating 120 is converged into the corresponding output-waveguide array 130 according to the wavelength of a signal light radiated from the one end of the input-waveguide array 110 (in which, A=0). That is, the signal light radiated from the optical-waveguide-array grating 120 is converged into one end of the corresponding output-waveguide array 130 based on the wavelength thereof.

dy/dλ=fm/n₁d Equation 5

In the above Equation 5, y represents the distance between one end of the output-waveguide array 130 and a converged point of the signal light. The relationship between the wavelength of the signal light and the position of the output-waveguide array 130 can be understood from Equation 5. That is, the output-waveguide array 130 shown in FIG. 1 is aligned with a predetermined interval according to Equation 5.

FIG. 2 shows a conventional wavelength-division multiplexer, which includes first and second star couplers 140 and 150, where the spaces formed between the input-waveguide array 110 and the optical-waveguide-array grating 120 and between the output-waveguide-array grating 130 and the optical-waveguide-array grating 120 are referred to as free-space regions or slabs.

Referring to FIGS. 2 and 3, an optical-signal band 300 inputted into the wavelength-division multiplexer is divided into s plurality of channels 400 each having a central wavelength. The wavelength-division multiplexer (WDM) typically outputs the optical signal in the form of gauss. Note that a WDM typically tends to generate a gauss-type wavelength and is inexpensive when compared to an optical-fiber grating used to create a plurality of channels.

However, the conventional WDM causes insertion loss due to its inherent design. Moreover, since the conventional wavelength-division multiplexer has a multiplexing wavelength, the stability of the transmitted optical signal is lowered due to the temperature variation and mismatch as the number of the channels is increased. In addition, the optical power of the optical signal in the form of gauss is formed differently at the ends of the bandwidth and the gauss. Thus, cross-talk is generated due to the overlapping of divided wavelengths of an input-optical-signal band, and a significant optical-signal loss is created due to variations in the external temperature and the mismatch in a planar optical-waveguide chip, thereby lowering the stability of the optical signal.

### SUMMARY OF THE INVENTION

Accordingly, the present invention has been made to solve the above-mentioned problems occurring in the prior art and offers additional advantages by providing a planar optical-waveguide chip having a plurality of bragg-fiber gratings that are connected to each other in series and which can reduce an optical-signal loss caused by the gauss channel and can be manufactured easily.

According to one aspect of the invention, there is provided a wavelength-division multiplexer for providing a plurality of optical-signal-transmitting channels by dividing an input-optical-signal band, the wavelength-division multiplexer comprising: an optical block for dividing the input-optical-signal band into a plurality of bragg wavelengths, including side lobes and for accommodating a plurality of bragg-fiber gratings connected to each other in series such that the peak of a side lobe is matched with the optical-signal-transmitting channel; an isolator for shutting off a part of the wavelengths of the input-optical-signal band, which is reflected from the bragg-fiber gratings; a planar waveguide-array-grating chip for dividing the input-optical-signal band, which is inputted from the optical-fiber block, into a plurality of channels; and, an output-terminal optical-fiber block connected to an output terminal of the planar waveguide-array-grating chip.

### BRIEF DESCRIPTION OF THE DRAWINGS

The above features and advantages of the present invention will be more apparent from the following detailed description taken in conjunction with the accompanying drawings, in which:

FIG. 1 is a view showing the optical-signal distribution of an optical-waveguide-array grating;

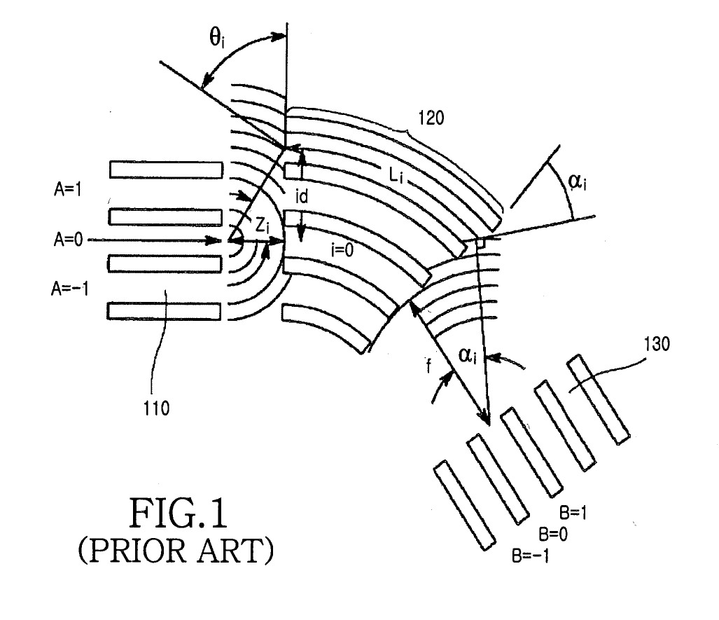

FIG. 2 is a view showing a conventional wavelength-division multiplexer;

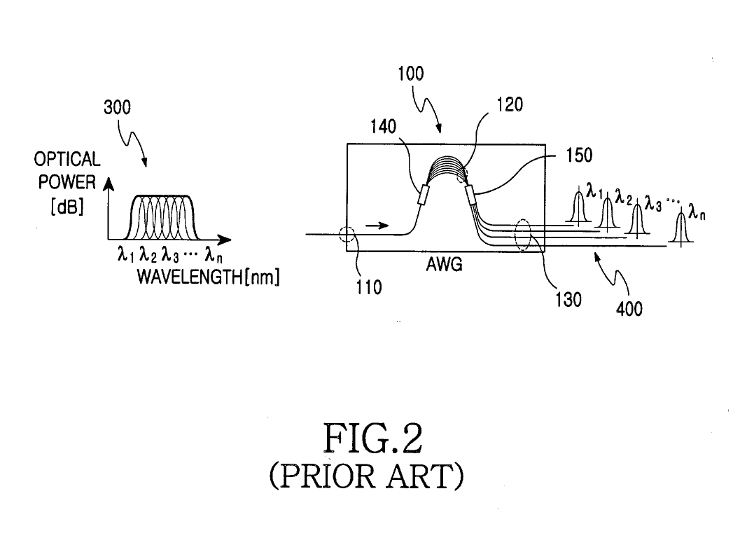

FIG. 3 is a graph showing the spectrum of an input-optical-signal band inputted into a conventional wavelength-division multiplexer;

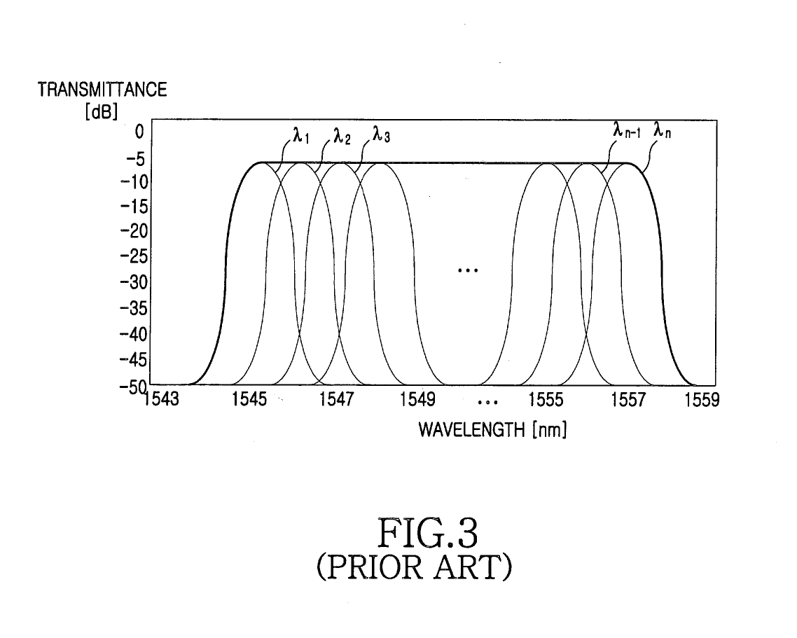

FIG. 4 is a view showing a wavelength-division multiplexer for forming a planar optical signal according to an embodiment of the present invention;

FIG. 5 is a graph showing the overlapping of adjacent wavelengths caused by a bragg-fiber grating according to an embodiment of the present invention; and,

FIG. 6 is a graph showing a spectrum of a planar optical signal outputted from an output terminal of the wavelength-division multiplexer according to an embodiment of the present invention.

### DETAILED DESCRIPTION OF THE PREFERRED EMBODIMENT

Hereinafter, a preferred embodiment of the present invention will be described with reference to the accompanying drawings. For the purposes of clarity and simplicity, a detailed description of known functions and configurations incorporated herein will be omitted as it may make the subject matter of the present invention unclear.

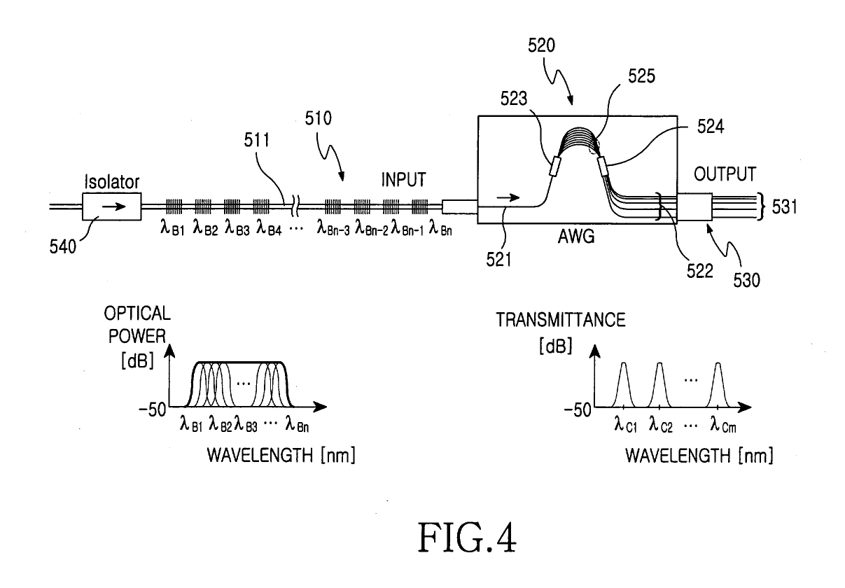

Referring to FIG. 4, the wavelength-division multiplexer according to the embodiment of the present invention includes an optical-waveguide-array-grating chip 520, an optical-fiber block 510 connected to an input waveguide 521 of the optical-waveguide-array-grating chip 520, an isolator 540 coupled to an input terminal of the optical-fiber block 510, and an output-terminal optical-fiber block 530 connected to an output terminal 522 of the optical-waveguide-array-grating chip 520.

The isolator 540 is connected to the input terminal of the optical-fiber block 510 serves to prevent an input optical signal reflected back in a reverse direction.

The optical-fiber block 510 comprises bragg-fiber gratings 511 disposed in series. The bragg-fiber gratings 511 are obtained by making the use of the characteristic of an optical fiber whereby the refraction rate of the optical fiber is maintained in a varied state for a long time if an ultraviolet ray is radiated into the optical fiber. That is, the bragg gratings are formed on a photosensitive optical fiber using a phase mask.

If the period of the bragg gratings is represented by P, the effective refraction rate of an optical-fiber core with respect to the central wavelength of the bragg is represented by neff, and the central wavelength of the bragg is represented by λB₁, then the following equation 1 is obtained.

λB₁=2 neff P Equation 1

In addition, if the distance in the lengthy direction of the optical fiber is represented by L, a refraction-rate profile of the bragg gratings is described as in equation 2.

n(L)=n_{avg}+Δn cos(2πL/P) Equation 2

In the above equation 2, Δ n represents an amplitude of the refraction rate induced into the optical-fiber core. In one period of the bragg gratings, the refraction rate in each point is represented as a constant waveform. The bragg grating, which maintains the constant amplitude of the refraction rate and the constant grating period with respect to the length of the whole bragg gratings formed in the optical-fiber core, is known as “bragg fiber grating.”

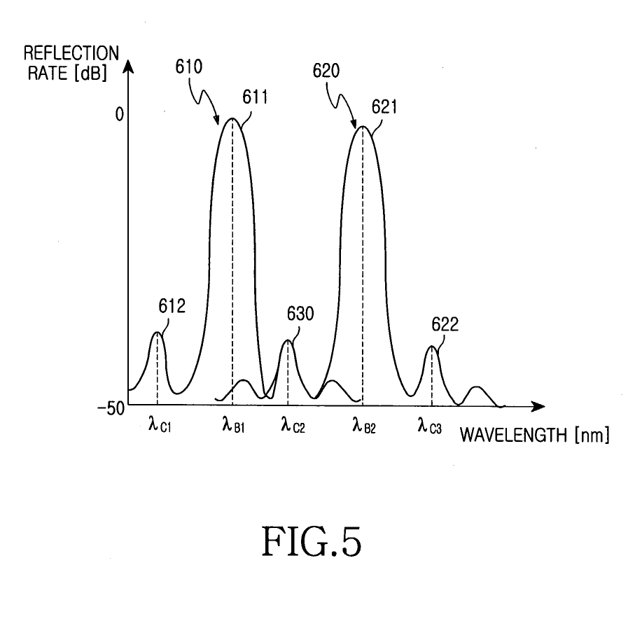

FIG. 5 is a reflection-rate graph showing the overlapping between the side lobes of bragg wavelengths outputted by the bragg-fiber grating. The first bragg wavelength 610 with a central wavelength of λB₁ includes a first main lobe 611 outputted in such a manner that its reference line matches with an input central wavelength and a first side lobe 612, which is a diffracted light having a different order from the first main lobe 611. In addition, a second bragg wavelength 620 with a central wavelength of λB₂ adjacent to λB₁ includes a second main lobe 621 and a second side lobe 622. Note that the second bragg wavelength 620 is overlapped with the first side lobe of the first bragg wavelength 610 at each channel of the optical-waveguide-array chip. The period of the bragg-fiber grating 511 is formed such that the adjacent wavelengths can be overlapped with each other. For example, an overlapping portion 630 between the side lobes of λB₁ and λB₂ is matched with the central wavelength of a divided optical signal outputted from each channel of the planar optical-waveguide-array chip 520. That is, the side lobes of each bragg wavelength outputted from the bragg-fiber grating are overlapped with each other at each channel of the optical-waveguide-array chip, so that a planar optical signal is ultimately outputted.

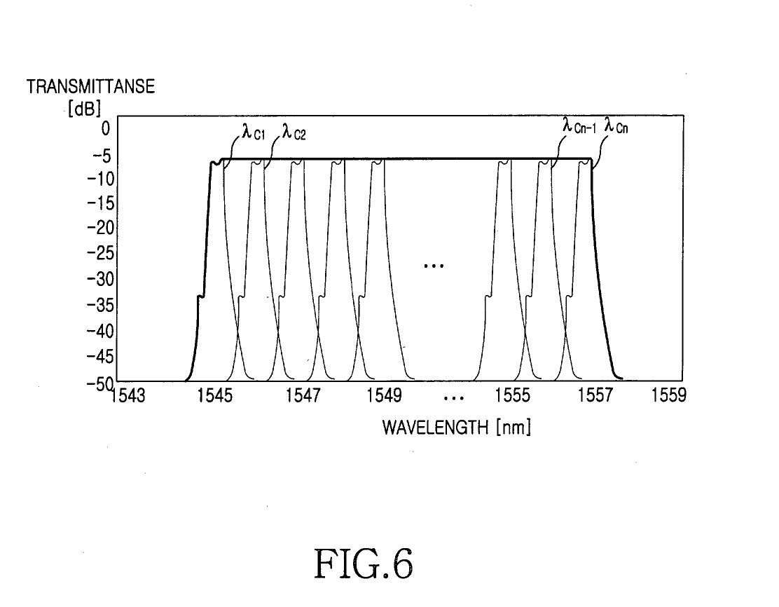

Referring to FIGS. 5 and 6, the optical-waveguide-array chip 520 includes the input terminal 521 connected to the optical-fiber block 510, an optical-waveguide array 525 for dividing an input optical signal, first and second star couplers 523 and 524, and the output terminal. When the input optical signal is inputted from the optical-fiber block 510, each central wavelength of output channels of the optical-waveguide-array chip 520 and the side lobes of the bragg wavelengths are overlapped. As a result, the side lobes of the bragg wavelengths are overlapped at each channel divided from the optical-waveguide-array-grating chip 520, thereby outputting the planar optical-signal pattern.

In the planar optical-signal wavelength, the optical power of information in the bandwidth is substantially constant, so the planar optical-signal wavelength is rarely influenced by external error factors, such as temperature variation or cross-talk, so that it is possible to transmit the optical signal in a stable manner and reduce the loss of the optical signal.

As described above, the wavelength-division multiplexer according to the present invention has the optical-fiber block including a plurality of bragg-fiber gratings aligned in series, so the channels divided from the planar optical-waveguide-array chip can be planarized easily. In addition, the loss of the optical signal can be reduced due to the planar channel. Furthermore, when compared to the gauss-type channel, the planar channel is not influenced by the optical-signal-error factors significantly including external environmental factors, such as temperature variation, nor by structural factors, such as an internal structure of the planar optical-waveguide-circuit chip, such that the planar channel can transmit the optical signal in a stable manner.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A wavelength-division multiplexer for providing a plurality of optical-signal-transmitting channels by dividing an input-optical-signal band, comprising:
an optical block having a plurality of bragg-fiber gratings connected in series for dividing the input-optical-signal band into a plurality of bragg wavelengths, the plurality of bragg wavelengths having a side lobe at each end; and
a planar-waveguide-array-grating chip for dividing the input-optical-signal band outputted from the optical-fiber block into a plurality of channels,
wherein a peak of a side lobe matches with the optical-signal-transmitting channel.

2. A wavelength-division multiplexer as claimed in claim 1, further comprising an isolator for preventing a part of the input-optical-signal band reflected from the bragg-fiber gratings to pass.

3. A wavelength-division multiplexer as claimed in claim 1, further comprising an output terminal connected to an output terminal of the planar waveguide-array-grating chip.

4. A wavelength-division multiplexer as claimed in claim 1, wherein the bragg-fiber gratings are spaced from each other by a predetermined distance and include a central wavelength corresponding to a wavelength formed at a middle point between a channel of the planar-waveguide-array-grating chip and an adjacent channel.

5. A method for manufacturing a wavelength-division multiplexer used for providing a plurality of optical-signal-transmitting channels, the method comprising the steps of:
providing a planar waveguide-array-grating chip having an input terminal and an output terminal for dividing the input-optical-signal band into a plurality of channels;
providing an optical block having a plurality of bragg-fiber gratings connected in series along a waveguide at the input terminal of the planar waveguide-array-grating chip to divide the input-optical-signal band into a plurality of bragg wavelengths; and,
providing a plurality of bragg-fiber gratings on the waveguide at a predetermined distance from each other in sequence, so that a peak of a side lobe of the bragg wavelength matches with the optical-signal-transmitting channel.

6. A method for manufacturing a wavelength-division multiplexer used for providing a plurality of optical-signal-transmitting channels, the method comprising the steps of:
providing a planar waveguide-array-grating chip having an input terminal and an output terminal for dividing the input-optical-signal band into a plurality of channels;
providing an optical block having a plurality of bragg-fiber gratings having a central wavelength connected in series along a waveguide at the input terminal of the planar waveguide-array-grating chip to divide the input-optical-signal band into a plurality of bragg wavelengths; and,
providing a plurality of bragg-fiber gratings on the waveguide at a predetermined distance from each other in sequence, so that the central wavelength corresponds to a wavelength formed at a middle point between a channel of the planar waveguide-array-grating chip and an adjacent channel.
